(19) United States
(12) Patent Application Publication
(10) Pub. No.: US 2014/0322558 A1
(43) Pub. Date: Oct. 30, 2014

(54) ALUMINUM ALLOY CLAD MATERIAL FOR FORMING

(71) Applicant: UACJ CORPORATION, Tokyo (JP)

(72) Inventors: Hiroki Takeda, Tokyo (JP); Akira Hibino, Tokyo (JP)

(21) Appl. No.: 14/356,072

(22) PCT Filed: Oct. 31, 2012
(86) PCT No.: PCT/JP2012/078242

§ 371 Date: May 2, 2014

(30) Foreign Application Priority Data
Nov. 2, 2011 (JP) 2011-241445

(51) Int. Cl. B32B 15/01; C22C 21/08

(52) U.S. Cl. CPC B32B 15/016; C22C 21/08
USPC 428/654

(57) ABSTRACT

An aluminum alloy clad material for forming includes: an aluminum alloy core material containing Mg: 3.0 to 10% (mass %, the same hereinafter), and the remainder being Al and inevitable impurities; an aluminum alloy surface material which is cladded on one side or both sides of the core material, the thickness of the clad for one side being 3 to 30% of the total sheet thickness, and which has a composition including Mg: 0.4 to 5.0%, and the remainder being Al and inevitable impurities; and an aluminum alloy insert material which is interposed between the core material and the surface material, and has a solidus temperature of 580° C. or lower.

### TECHNICAL FIELD

The present disclosure relates to an aluminum alloy clad material for a forming which is subjected to a forming and used as a material for a variety of members or parts of automobiles, watercraft, aircraft, or the like such as an automotive body sheet or a body panel, or building materials, structural material, and a variety of machines and instruments, home electric appliances and parts thereof, or the like.

### BACKGROUND ART

Conventionally, as an automotive body sheet, a cold rolled steel sheet has been primarily used in many cases; recently, from the viewpoint of reducing the weight of an automotive body, or the like, an aluminum alloy rolled sheet is increasingly used. By the way, since an automotive body sheet is subjected to press working to be used, an automotive body sheet needs to have a high strength and at the same time good press formability. Currently, for such an aluminum alloy for an automotive body sheet, Al—Mg—Si based alloy or Al—Mg—Si—Cu based alloy having age hardening ability is primarily used other than Al—Mg based alloy. Among the above, Al—Mg based alloy containing a high composition of Mg is widely used for an automotive body panel since a high strength is obtained and the alloy has a good formability and corrosion resistance.

By increasing the amount of Mg to be added, the strength and formability increase. On the other hand, since Mg is a component which adversely affects the stress corrosion cracking (SCC) resistance and stretcher-strain (SS) mark resistance, when a high composition of Mg is added, an SCC or SS mark is likely to be generated. Due to this, in the case of, for example, an automotive body sheet material in which a variety of performances such as press formability, strength, corrosion resistance, and surface quality are needed, a sheet composed of single alloy may be hard to satisfy all needs. As means for solving such problems, use of a cladding material consisting of cladding sheet materials each having different properties as described in Patent Literature 1 is proposed.

### CITATION LIST

### Patent Document

Patent Document 1: National Patent Publication No. 2009-535508

### SUMMARY OF INVENTION

### Technical Problem

As an industrial production process for an aluminum alloy clad material, a method in which aluminum or aluminum alloy sheet materials are layered to bond the interface by hot rolling (hot rolled clad) is generally used, and the method is currently widely used in manufacturing of a blazing sheet which is used as a heat exchanger or the like. However, in cases in which Al—Mg-based alloy for an automotive body sheet is subjected to a clad rolling in accordance with an ordinary method, since an adhesion failure between a core material and a surface material is likely to occur, causing a variety of problems such as peeling at the joining interface, cladding ratio failure, abnormality of the quality in which the material surface swells locally, and decrease in the productivity of a cladding material, practical use thereof in a mass production scale is difficult.

The present disclosure is made in view of the above-mentioned circumstances, and directed to providing an aluminum alloy clad material for forming in which a high mass productivity is attained, as well as particularly good strength, formability, SCC resistance and SS mark resistance are obtained.

### Solution to Problem

In order to attain the above-mentioned objective, the aluminum alloy clad material for forming of the present disclosure comprises:

an aluminum alloy core material containing Mg: 3.0 to 10% (mass %, the same hereinafter), and the remainder being Al and inevitable impurities;

an aluminum alloy surface material that is cladded on one side or both sides of the core material, the thickness of the clad for one side being 3 to 30% of the total sheet thickness, and that has a composition including Mg: 0.4 to 5.0%, and the remainder being Al and inevitable impurities; and

an aluminum alloy insert material that is interposed between the core material and the surface material, and has a solidus temperature of 580° C. or lower.

Preferably, in the aluminum alloy clad material for forming,

the core material and the surface material, or either thereof contains one or more of Zn: 0.01 to 2.0%, Cu: 0.03 to 2.0%, Mn: 0.03 to 1.0%, Cr: 0.01 to 0.40%, Zr: 0.01 to 0.40%, V: 0.01 to 0.40%, Fe: 0.03 to 0.5%, Si: 0.03 to 0.5%, and Ti: 0.005 to 0.30%.

Preferably, in the aluminum alloy clad material for forming,

setting the amount of Si (mass %, the same hereinafter) contained in the insert material to x and the amount of Cu (mass %, the same hereinafter) contained in the insert material to y, the following expressions (1) to (3) are satisfied at the same time:

x≧0 (1)

y≧0 (2)

y≧−11.7x+2.8 (3).

Preferably, in the aluminum alloy clad material for forming,

the amount of Mg contained in the insert material is 0.05 to 2.0 mass %, and

setting the amount of Si (mass %, the same hereinafter) contained in the insert material to x, and the amount of Cu (mass %, the same hereinafter) contained in the insert material to y, the following expressions (4) to (6) are satisfied at the same time:

x≧2 (4)

y≧0 (5)

y≧−10.0x+1.0 (6).

Preferably, in the aluminum alloy clad material for forming,

the solidus temperature of the insert material is lower than the solidus temperature of the core material and the solidus temperature of the surface material.

Preferably, in the aluminum alloy clad material for forming,

the thickness of the insert material when the core material, the insert material and the surface material are bonded in a high-temperature heat treatment is 10 m or larger.

### Advantageous Effects of Invention

According to the present disclosure, since an adhesion failure of Al—Mg based alloy during clad rolling can be effectively prevented, an aluminum alloy clad material for forming in which a high mass productivity is attained, as well as particularly good strength, formability. SCC resistance and SS mark resistance are obtained is obtained.

### BRIEF DESCRIPTION OF DRAWINGS

FIG. 1 is a phase diagram of Al—Si alloy showing the relationship between the composition and the temperature of an insert material; and

FIGS. 2A to 2D are pattern diagrams illustrating a generation process of a liquid phase of the insert material.

### DESCRIPTION OF EMBODIMENTS

In the following, an embodiment of the present disclosure will be specifically described.

In order to solve the above-mentioned problems, the present inventors have repeatedly performed a variety of experiments and studies to find that an adhesion failure can be prevented by bonding a core material and a surface material via an insert material before rolling, thereby completing the disclosure.

A core material and a surface material used for an aluminum alloy clad material of the disclosure is basically Al—Mg based alloy, and the specific component composition thereof may be appropriately adjusted in accordance with a needed performance level. In cases in which strength, formability, SCC resistance and SS mark resistance are especially emphasized, alloy having such a component composition as in the present embodiment is preferably employed. In the following, the reason for restricting the component composition of material alloy will be described.

### Alloy Composition of Core Material

First, the reason for restricting the component composition of a core material will be described. The core material is demanded to have an excellent formability and a high strength. In order to attain an excellent formability and a high strength. Al—Mg based alloy with a high Mg composition is used as the core material.

Mg:

Mg is a fundamental alloy component for alloy system which is a subject of the disclosure, and is a component to be added which contributes to improvement of the strength, elongation, and deep drawability. When the amount of Mg is less than 3.0 mass %, the strength, elongation and formability becomes insufficient; on the other hand, when the amount of Mg is above 10 mass %, oxidation during dissolution or deterioration in rollability occurs, thereby considerably reducing manufacturability. Therefore, the amount of Mg contained is from 3.0 mass % to 10 mass %. In cases in which the strength and formability are particularly emphasized, the lower limit of the content of Mg is more preferably 5.5 mass %.

In accordance with the purpose, one or more of the followings may be added.

Zn, Cu, Mn, Cr, Zr, V, Fe, Si, Ti:

Both Zn and Cu are a component which is effective in improving the strength, and either or both thereof are added as needed. When the content of Zn is 0.01 mass % or higher and the content of Cu is 0.03 mass % or higher, the effect thereof can be sufficiently obtained; when the contents of Zn and Cu are 2.0 mass % or lower, reduction in the formability is inhibited while inhibiting reduction in the corrosion resistance. Therefore, the content of Zn is preferably from 0.01 mass % to 2.0 mass %, and the content of Cu is preferably from 0.03 mass % to 2.0 mass %.

Mn, Cr, Zr, and V are a component which has an effect for improvement of the strength, micronization of a crystal grain, and stabilization of the structure. When the content of Mn is 0.03 mass % or higher or when each of the contents of Cr, Zr, and V is 0.01 mass % or higher, the above-mentioned effect can be sufficiently obtained. When the content of Mn is 1.0 mass % or lower, or when each of the contents of Cr, Zr, and V is lower than 0.40 mass %, the above-mentioned effect is sufficiently maintained and at the same time, an adverse effect on the formability due to generation of a large amount of intermetallic compound can be inhibited. Therefore, the amount of Mn is preferably in a range of 0.03 mass % to 1.0 mass %, and each of the contents of Cr, Zr, V is preferably in a range of 0.01 mass % to 0.40 mass %.

Fe and Si are also a component which is effective for improving the strength and micronization of crystal grain in a similar manner to the above-mentioned Mn, Cr, Zr, V and the like. When each of the contents thereof is 0.03 mass % or higher, a sufficient effect can be obtained; when each of the contents thereof is 0.5 mass % or lower, deterioration of the press formability due to generation of a large amount of intermetallic compound can be inhibited. Therefore, the amounts of Fe and Si are preferably from 0.03 mass % to 0.5 mass %.

Ti is a component to be added for micronization of an ingot structure. When the content of Ti is 0.005 mass % or higher, a sufficient effect can be obtained; when the content of Ti is 0.30 mass % or lower, generation of coarse crystallized product can be inhibited while maintaining the effect of addition of Ti. Therefore, the amount of Ti is preferably in a range of 0.005 mass % to 0.3 mass %. Since B is added together with Ti, by the addition of B together with Ti, the effect of micronization and stabilization of ingot structure becomes more evident. Also in the case of the disclosure, addition of B in an amount of 500 ppm or smaller together with Ti is allowed.

The alloy material preferably comprises, other than the above-mentioned components, basically Al and inevitable impurities.

Be is also generally added to alloy containing Mg for preventing oxidation of molten metal during casting. Also in the case of the present disclosure. Be in an amount of 500 ppm or smaller may be added.

### Alloy Composition of Surface Material

Next, the reason for restricting the component composition of a surface material will be described. A surface material is demanded to improve the SCC resistance and SS mark resistance and has minimally required surface hardness as an automotive body sheet material.

Mg:

Mg is a fundamental alloy component for alloy system which is a subject of the disclosure, and is a component to be added which contributes to improvement of the strength, elongation, and deep drawability. When the amount of Mg is above 5.0 mass %, the SCC resistance and SS mark resistance extremely deteriorate; on the other hand, when the amount of Mg is smaller than 0.40 mass %, the surface hardness becomes insufficient. Therefore, the content of Mg is from 0.40 mass % to 5.0 mass %. In cases in which the surface hardness is particularly emphasized, the lower limit of the content of Mg is more preferably 0.80 mass %; particularly, in cases in which the SCC resistance and SS mark resistance are emphasized, the upper limit of the content of Mg is further preferably 3.5 mass %. In cases in which the SS mark resistance is further emphasized, the upper limit of the content of Mg is more preferably 2.5 mass % or lower.

The ranges of the component compositions of other components than Mg are similar to that of the above-mentioned core material.

Here, more preferably, the content of Mg in the surface material is basically smaller than the content of Mg in a core material to be combined also in the above-mentioned range of the alloy composition. This is because, when the content of Mg in the surface material is smaller than the content of Mg in the core material, an effect of improving the SCC resistance and SS mark resistance can be further obtained.

Next, the reason for restricting the sheet thickness of the surface material will be described. The ratio of the sheet thickness of the surface material with respect to the total sheet thickness (cladding ratio) is 3 to 30% for one side, and the surface material is cladded on one side, or on both sides as needed. When the cladding ratio is below the lower limit of the above range, the SCC resistance and SS mark resistance which the surface material has are not sufficiently exhibited. When the cladding ratio is above the upper limit, performances which the core material is to exhibit represented by the strength, formability, and the like are largely deteriorated. In cases in which the SS mark resistance is particularly emphasized, the lower limit of the cladding ratio is more preferably 10%.

Next, an aluminum alloy insert material used for an aluminum alloy clad material of the disclosure will be described.

Basically, in cases in which a cladding material using Al—Mg based alloy as a core material or surface material is manufactured by rolling, the core material and the surface material are likely to be peeled due to the influence of an oxide film existing on the surface of the alloy, or the difference between the deformation resistances of the core material and the surface material, which prevents the practical application thereof in a mass production scale. In the present disclosure, for the purpose of resolving an adhesion failure during clad rolling, an aluminum alloy insert material is inserted between the core material and the surface material. By a bonding method which utilizes a minute liquid phase which is generated inside the insert material by performing a high-temperature heating, the core material and the insert material, and the surface material and the insert material are individually bonded with each other metallically, thereby preventing interface peeling during rolling. Since, as the result, rolling is completed without generating interface peeling, a cladding material in which the bonded interface has no adhesion failure and which is tightly bonded can be surely and stably obtained in a mass production scale. Since such insertion of the insert material is useful for resolving an adhesion failure of an alloy of a kind in which clad rolling as mentioned above is difficult as well as for preventing an adhesion failure of an alloy of a kind in which cladding technique is established, the insertion is effective for improving the productivity and attaining a cladding ratio which is difficult to attain by a conventional method.

Here, the aluminum alloy insert material is expected to improve the adhesion failure. In cases in which Al—Mg based alloy is used as a material of the core material and the surface material, in order to prevent bonded interface peeling during rolling, the sheet thickness of the insert material when the insert material and the core material, and surface material are individually bonded with each other by a high-temperature heat treatment is preferably 10 μm or larger. When the thickness is 10 μm or larger, an amount of liquid phase in which a favorable bonding is obtained can be secured, and interface peeling during rolling can be inhibited. When the thickness of the insert material is more preferably 50 μm or larger and further preferably 100 μm or larger, bonded interface peeling can be more surely prevented. A preferred sheet thickness of an insert material for the purpose of preventing bonded interface peeling which has been described here does not change depending on the sheet thickness of the core material and the surface material, and the upper limit of the sheet thickness of the insert material is not particularly restricted. On the other hand, the existence of the insert material desirably has no influence on other properties such as the press formability, the strength, the corrosion resistance, or the surface quality. In this respect, the present inventors repeated experiments to find that, further suitably, the ratio of the insert material with respect to the total sheet thickness is 1.0% or lower for one side. In such a range of the sheet thickness, the properties of the insert material do not inhibit the effect of the core material or the surface material. For such a purpose, the lower limit value of the ratio of the insert material is not particularly limited. As mentioned above, the upper limit and the lower limit of the sheet thickness of the insert material are determined depending on separate purposes mentioned above. Preferably, the lower limit value and the upper limit value are set so as to satisfy a preferred sheet thickness during a high-temperature heat treatment and so as to satisfy a preferred ratio with respect to the total sheet thickness, respectively.

In the following, the mechanisms of generation of a liquid phase and bonding will be described in more detail.

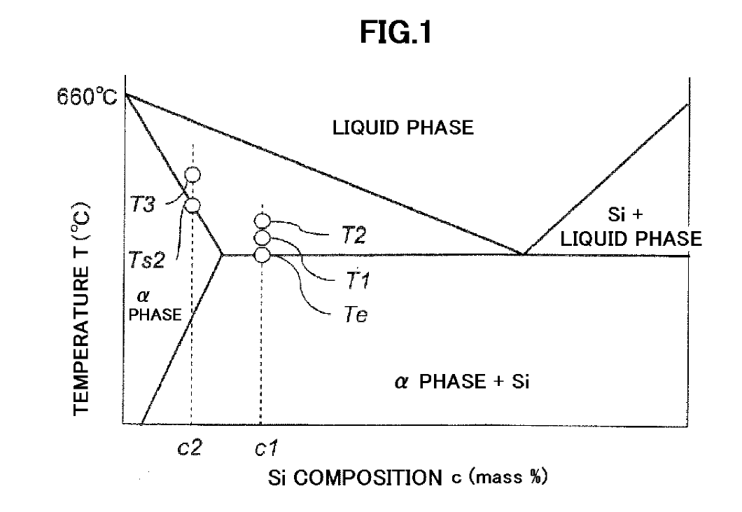

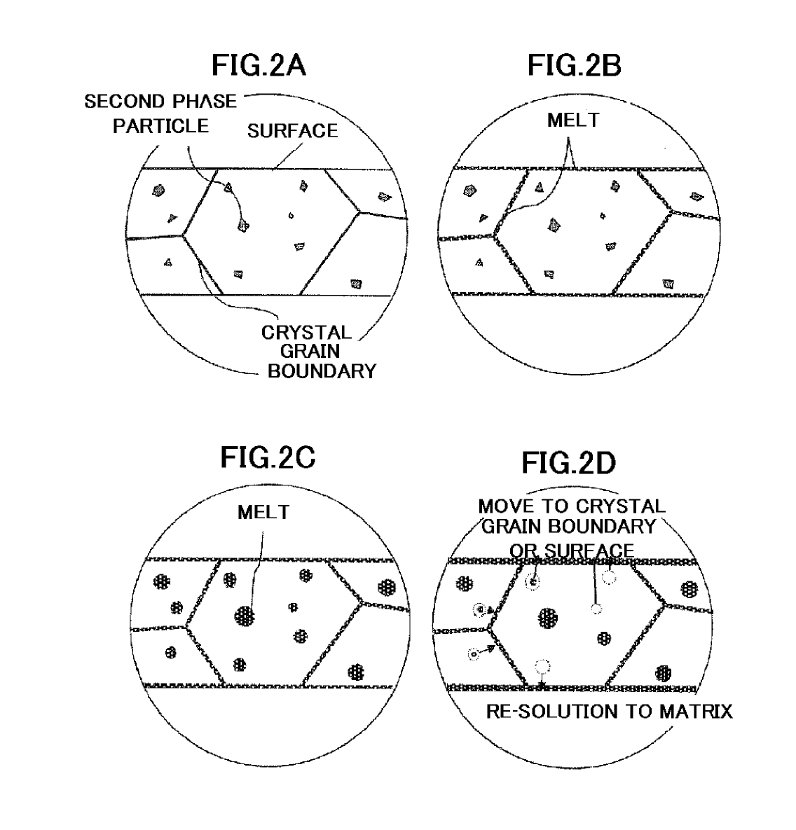

FIG. 1 schematically illustrates a phase diagram of Al—Si alloy which is a representative binary eutectic alloy. In cases in which the composition of the insert material has a Si composition of c1, after heating, generation of a liquid phase begins at a temperature of T1 near a temperature above the eutectic temperature (solidus temperature) Te. When the temperature is eutectic temperature Te or lower, as illustrated in FIG. 2A, second phase particle is distributed in a matrix sectioned by crystal grain boundaries. Here, when generation of the liquid phase begins, as illustrated in FIG. 2B, the crystal grain boundary on which there is a large amount of particle or the composition of a solid solution component is high due to intergranular segregation melts into a liquid phase. Subsequently, as illustrated in FIG. 2C, Si second phase particles which are a component added mainly dispersed in a matrix of an aluminum alloy, or the surrounding of intermetallic compounds are spherically molten into a liquid phase. Further, as illustrated in FIG. 2D, the spherical liquid phase generated in the matrix is re-soluble due to an interface energy with the passage of time or rise in the temperature, and moves to the crystal grain boundary or the surface by solid phase diffusion.

Next, as illustrated in FIG. 1, when the temperature rises to T2, the amount of liquid phase increases according to the phase diagram. As illustrated in FIG. 1, in cases in which the Si composition of the insert material is c2, generation of a liquid phase begins in the same manner as in c1 at a temperature near a temperature above a solidus temperature Ts2, and when the temperature rises to T3, the amount of liquid phase increases according to the phase diagram. As mentioned above, the liquid phase generated on the surface of the insert material during bonding fills a gap with the core material or the surface material, and then, the liquid phase near the bonded interface moves towards the core material or the surface material. With this movement, a crystal grain of the insert material's solid phase (alpha phase) grows toward the inside of the core material or surface material, thereby attaining metal bonding. As mentioned above, the bonding method according to the present disclosure utilizes a liquid phase generated by partial melting inside the insert material.

In bonding of the present disclosure, in cases in which the sheet thickness of the insert material is in the range mentioned above, favorable bonding is attained if the temperature is a solidus temperature judged from an endothermic peak by Differential Thermal Analysis (DTA) or higher. In cases in which a bonding failure is desired to be more surely prevented, the mass ratio of the liquid phase is preferably 5% or higher, and more preferably 10% or higher. Even when the insert material is completely molten, there is no problem in the present disclosure, but the insert material is not needed to be completely molten.

As is obvious from the above, in cases in which metal bonding is not formed without heating up to the solidus temperature of the insert material even when the insert material is inserted, it becomes difficult to obtain a cladding material without an adhesion failure. The present inventors repeated experiments to find that, in order to attain favorable bonding without an adhesion failure, insertion of the insert material and heating to the solidus temperature of the insert material or above are needed.

Since Al—Mg based alloy used as a core material, or a surface material may undergo eutectic melting accompanying performance deterioration at a temperature above 580° C., a high-temperature heat treatment performed before rolling is normally performed at a temperature of 580° C. or lower. Therefore, the solidus temperature of the aluminum alloy insert material needs to be 580° C. or lower. Since a small amount of a liquid phase needs to be generated, retention time for the high-temperature heating may be from 5 minutes to 48 hours. Further, from the viewpoint of energy saving, since the lower the temperature of the high-temperature heat treatment, the better, the solidus temperature of the insert material is preferably 560° C. or lower. Depending on the composition of the core material, or the surface material it can be thought that the solidus temperature is 580° C. or lower, the high-temperature heat treatment is preferably performed at the solidus temperature of the core material or the surface material or lower in order to avoid deterioration in the performance of the cladding material. On the other hand, since, in order to prevent a bonding failure, as mentioned above, a high-temperature heating at the solidus temperature of the insert material or higher is needed to be performed, more preferably, the solidus temperature of the insert material is lower than each of the solidus temperatures of the core material and the surface material.

### Alloy Composition of Insert Material

The solidus temperature of the aluminum alloy insert material used for an aluminum alloy clad material of the disclosure may be 580° C. or lower, and the specific component composition thereof is not particularly restricted, and, in view of productivity, Al—Cu based. Al—Si based or Al—Cu—Si based alloy is suitably used.

Here, both Cu and Si are a component which has an effect of considerably decreasing the solidus temperature by adding to aluminum. The present inventors studied a range of the composition in which a cladding material having a favorable performance without an adhesion failure is obtained when Al—Cu based, Al—Si based or Al—Cu—Si based alloy is used as the insert material to find that, setting the amount of Si to x, and the amount of Cu to y, the following expressions (1) to (3) are more preferably satisfied at the same time:

x≧0 (1)

y≧0 (2)

y≧−11.7x+2.8 (3)

Although the upper limit of Cu, Si is not particularly restricted in view of exhibiting functions of the insert material needed in the present disclosure, when the productivity such as castability, or rollability is taken into account, preferably, Cu is 10 mass % or smaller, and Si is 15 mass % or smaller.

Examples of the other components having an effect that the solidus temperature is considerably decreased include Mg. In the present disclosure, Mg may be added to the above-mentioned Al—Cu based, Al—Si based, or Al—Cu—Si based alloy as needed. When the content of Mg is 0.05 mass % or higher, an effect of decreasing the solidus temperature can be sufficiently obtained; and when the content of Mg is 2.0 mass % or lower, interference of bonding to the top surface of the insert material during a high-temperature heating due to formation of a thick oxide film is inhibited. Therefore, the amount of Mg is preferably in a range of 0.05 mass % to 2.0 mass %. Even when the above-mentioned Al—Cu based, Al—Si based, or Al—Cu—Si based alloy contains Mg in an amount smaller than the lower limit defined here, functions of the insert material are not compromised.

The present inventors studied in a similar manner a range of the composition in which a cladding material without an adhesion failure is obtained when Al—Cu based, Al—Si based or Al—Cu—Si based alloy is used as the insert material to find that, setting the amount of Si to x, and the amount of Cu to y, the following expressions (4) to (6) are more preferably satisfied at the same time:

x≧0 (4)

y≧0 (5)

y≧−10.0x+1.0 (6)

Here, one or more components other than the above-mentioned Cu, Si, and Mg such as Fe, Mn, Sn, Zn, Cr, Zr, Ti, V, B, Ni, and Sc are allowed to be contained to a degree that functions of the insert material are not inhibited. More particularly, Fe and Mn may be added in an amount of 3.0 mass % or smaller. Sn and Zn may be added in an amount of 10.0 mass % or smaller, and Cr, Zr, Ti, V, B, Ni, and Sc may be added in an amount of 1.0 mass % or smaller for the purpose of improving the castability, rollability, or the like. In the same manner, inevitable impurities are allowed to be contained.

In the following, a manufacturing method of an aluminum alloy clad material sheet for forming of the disclosure will be described.

Each of the core material, surface material, and insert material which constitute an aluminum alloy clad material of the present disclosure may be manufactured in accordance with an ordinary method. For example, first, an aluminum alloy having a component composition as mentioned above is manufactured in accordance with a conventional method, and subjected to casting by appropriately selecting a normal casting such as continuous casting, or semi-continuous casting (DC casting). In cases in which the thickness needs to be reduced to obtain a predetermined sheet thickness, a homogenizing treatment is performed as needed, and then hot rolling or cold rolling, or both thereof may be performed. Other than the above, a predetermined sheet thickness may be obtained by machine cutting or a combination of rolling and machine cutting, or the like.

Subsequently, the core material, surface material, insert material having a predetermined sheet thickness are layered such that the insert material is inserted between the core material and the surface material. The surface material and the insert material may be layered on one side, or both sides as needed. For the purpose of removing an oxide film at the bonded interface, a flux may be applied to the bonded portion as needed. In the present disclosure, however, bonded interface peeling can be sufficiently prevented during rolling even without applying a flux. As needed, the core material, surface material, and insert material after layering may be fixed by welding. Welding may be performed in accordance with a conventional method, and it is preferably performed, for example, in conditions of an electric current of 10 to 400 A, a voltage of 10 to 40V, and a welding speed of 10 to 200 cm/min. Still further, fixation of the core material, surface material, and insert material by a fixing instrument such as an iron band causes no problems. After layering, a high-temperature heating for bonding utilizing a liquid phase of the insert material is performed as mentioned above. More efficiently, the high-temperature heating is performed also as a homogenizing treatment which is normally performed for Al—Mg based alloy which constitutes the core material and surf ace material.

A temperature in cases in which the high-temperature heat treatment is performed is at least the solidus temperature of the insert material or higher, and as mentioned above, the temperature is 580° C. or lower depending on the solidus temperature of the insert material, and preferably at a temperature 560° C. or lower. The retention time may be 5 minutes to 48 hours. When the retention time is 5 minutes or longer, favorable bonding can be obtained. When the retention time is 48 hours or shorter, a heating treatment can be performed economically with maintaining the above effect. Although the high-temperature heat treatment can be sufficiently performed under an oxidizing atmosphere such as under an atmospheric furnace, in order to more surely preventing interface peeling, the high-temperature heat treatment is preferably performed under a non-oxidizing atmosphere in which an oxidizing gas such as oxide is not contained. Examples of the non-oxidizing atmosphere include vacuum, inert atmosphere and reducing atmosphere. The inert atmosphere refers to an atmosphere filled with an inert gas such as nitrogen, argon, helium, or neon. The reducing atmosphere refers to an atmosphere in which a reducing gas such as hydrogen, monoxide, or ammonium exists. In order to have a sufficient homogenizing treatment effect by a heating treatment, the lower limit of the temperature may be 450° C. or higher. After the homogenizing treatment, hot rolling and cold rolling are performed in accordance with normal conditions to obtain a cladding material having a predetermined sheet thickness. The process annealing may be performed as needed.

In the case of Al—Mg-based alloy, as a recrystallization heat treatment, annealing whose main purpose is recovery and recrystallization is performed. In this case, the heating temperature of the annealing is preferably in a range of 310 to 580° C. When the annealing temperature is 310° C. or higher, recrystallization becomes sufficient; when the annealing temperature is 580° C. or lower, generation of local melting can be inhibited. In cases in which the annealing is performed in a batch furnace, a condition of retention at 310 to 450° C. for 0.5 to 24 hours is preferred. On the other hand, in cases in which the annealing is performed in a Continuous Annealing Line (CAL), a condition of retention at 400 to 580° C. for zero to 5 minutes is preferred. By setting the intermediate temperature between the solidus temperature and the liquidus temperature of the insert material to Tc, and heating in a temperature range less than Tc, a strong melt with an insert layer does not occur, and deterioration of properties of the material can be inhibited, and therefore, the material attainable temperature is preferably lower than TC also in the above range. The upper limit of the material attainable temperature when a process annealing is performed as needed is more desirably 580° C. or lower and lower than Tc.

The present disclosure is not limited to the above-described Embodiments, and a variety of modifications and applications are possible.

### EXAMPLES

In the following, Examples are described together with Comparative Examples. The following Examples are for describing the effect of the disclosure, and the processes and conditions described in the Examples should not be construed as a limitation of the technical scope of the disclosure.

First, alloy signs B to O each having the component composition listed on Table I to be used as a material of a core material or a surface material, and alloy signs A, P, and Q to be used in Comparative Examples, and alloy signs 3 to 5, 7 to 29, 32 to 57 each having the component composition listed on Tables 2 and 3 to be used as a material of an insert material, and alloy signs 1, 2, 6, and 30 to 31 of Comparative Example of the insert material were manufactured in accordance with a conventional method, and subjected to casting into a slab by a DC casting. In Table 1, an alloy having a component composition which departs from the scope of the present disclosure is indicated as “Comparative Example”. In Tables 2 to 3, an insert material having a solidus temperature which departs from the scope of the present disclosure is indicated as “Comparative Example”.

TABLE 1

| | Alloy | Alloy component composition of core material and surface material (unit: mass %) | | | | | | | | | | | |
|---|---|---|---|---|---|---|---|---|---|---|---|---|---|
| Category | sign | Mg | Si | Fe | Cu | Mn | Cr | Zn | Zr | V | Ti | Al | Note |
| Comparative | A | 0.21 | 0.16 | 0.21 | 0.19 | 0.15 | 0.10 | 0.20 | 0.04 | 0.05 | 0.01 | Balance | Low Mg |
| Example | | | | | | | | | | | | | |
| Within | B | 0.53 | 0.11 | 0.11 | 0.25 | 0.21 | 0.04 | — | — | — | 0.02 | Balance | |
| range of | C | 0.82 | 0.09 | 0.10 | 0.41 | 0.03 | — | — | — | — | 0.01 | Balance | |
| surface | D | 0.99 | 0.38 | 0.43 | 0.02 | 0.02 | — | — | — | — | — | Balance | |
| material | E | 1.43 | 0.14 | 0.17 | 0.12 | 0.05 | — | — | — | — | 0.02 | Balance | |
| composition | F-1 | 1.91 | 0.01 | 0.02 | — | — | — | — | — | — | — | Balance | |
| of the | F-2 | 1.91 | 0.30 | 0.02 | — | — | — | — | — | — | — | Balance | |
| present | F-3 | 1.91 | 0.01 | 0.30 | — | — | — | — | — | — | — | Balance | |
| disclosure | F-4 | 1.91 | 0.01 | 0.02 | 1.01 | — | — | — | — | — | — | Balance | |
| | F-5 | 1.91 | 0.01 | 0.02 | — | 0.41 | — | — | — | — | — | Balance | |
| | F-6 | 1.91 | 0.01 | 0.02 | — | — | 0.21 | — | — | — | — | Balance | |
| | F-7 | 1.91 | 0.01 | 0.02 | — | — | — | 1.00 | — | — | — | Balance | |
| | F-8 | 1.91 | 0.01 | 0.02 | — | — | — | — | 0.21 | — | — | Balance | |
| | F-9 | 1.91 | 0.01 | 0.02 | — | — | — | — | — | 0.20 | — | Balance | |
| | F-10 | 1.91 | 0.01 | 0.02 | — | — | — | — | — | — | 0.15 | Balance | |
| | G | 2.74 | 0.15 | 0.21 | — | — | 0.18 | — | — | — | — | Balance | Equivalent |
| | | | | | | | | | | | | | to AA5052 |
| | H | 3.23 | 0.10 | 0.14 | — | — | — | — | — | — | — | Balance | |
| | I-1 | 4.07 | 0.01 | 0.01 | — | — | — | — | — | — | — | Balance | |
| | I-2 | 4.07 | 0.31 | 0.01 | — | — | — | — | — | — | — | Balance | |
| | I-3 | 4.07 | 0.01 | 0.32 | — | — | — | — | — | — | — | Balance | |
| | I-4 | 4.07 | 0.01 | 0.01 | 1.03 | — | — | — | — | — | — | Balance | |
| | I-5 | 4.07 | 0.01 | 0.01 | — | 0.40 | — | — | — | — | — | Balance | |
| | I-6 | 4.07 | 0.01 | 0.01 | — | 0.92 | — | — | — | — | — | Balance | |
| | I-7 | 4.07 | 0.01 | 0.01 | — | — | 0.21 | — | — | — | — | Balance | |
| | I-8 | 4.07 | 0.01 | 0.01 | — | — | — | 0.01 | — | — | — | Balance | |
| | I-9 | 4.07 | 0.01 | 0.01 | | | | 0.50 | | | | Balance | |
| | I-10 | 4.07 | 0.01 | 0.01 | — | — | — | 1.00 | — | — | — | Balance | |
| | I-11 | 4.07 | 0.01 | 0.01 | — | — | — | — | 0.19 | — | — | Balance | |
| | I-12 | 4.07 | 0.01 | 0.01 | — | — | — | — | — | 0.20 | — | Balance | |
| | I-13 | 4.07 | 0.01 | 0.01 | — | — | — | — | — | — | 0.15 | Balance | |
| | J | 4.98 | 0.12 | 0.11 | 0.14 | 0.21 | 0.06 | 0.08 | — | — | 0.02 | Balance | Equivalent |
| | | | | | | | | | | | | | to AA5182 |
| | K | 5.20 | 0.15 | 0.18 | 0.02 | 0.01 | — | — | — | — | 0.01 | Balance | |
| | L | 5.54 | 0.12 | 0.15 | 0.02 | 0.01 | — | — | — | — | — | Balance | |
| | M | 5.93 | 0.08 | 0.35 | 0.09 | 0.03 | — | — | 0.10 | 0.04 | 0.01 | Balance | |
| | N | 6.98 | 0.09 | 0.10 | 0.01 | — | 0.05 | — | — | 0.11 | 0.02 | Balance | |
| | O | 9.00 | 0.10 | 0.09 | 0.01 | — | — | 0.02 | 0.19 | — | — | Balance | |
| Comparative | P | 12.04 | 0.10 | 0.10 | 0.01 | 0.05 | 0.09 | — | — | — | 0.01 | Balance | High Mg |
| Example | Q | — | — | — | — | — | — | — | — | — | — | Balance | 99.99% Al |

TABLE 2

| Alloy | Alloy component composition of insert material (unit: mass %) | | | | | | | | |
|---|---|---|---|---|---|---|---|---|---|
| sign | Si | Cu | Mg | Others | | | | Al | Note |
| 1 | — | 0.99 | — | | | | | Balance | Comparative |
| | | | | | | | | | example |
| 2 | — | 2.51 | — | Ni: 0.01 | Sn: 0.02 | | | Balance | Comparative |
| | | | | | | | | | example |
| 3 | — | 3.04 | — | Ni: 0.01 | Sn: 0.02 | | | Balance | |
| 4 | — | 4.97 | — | Cr: 0.98 | | | | Balance | |
| 5 | — | 9.00 | — | | | | | Balance | |
| 6 | 0.10 | — | — | | | | | Balance | Comparative |
| | | | | | | | | | example |
| 7 | 0.15 | 1.52 | — | Mn: 0.98 | Sn: 0.31 | Fe: 0.15 | Ni: 0.11 | Balance | |
| 8 | 0.25 | — | — | Sn: 0.92 | Zn: 0.51 | Ni: 0.05 | | Balance | |
| 9 | 0.61 | 2.01 | — | | | | | Balance | |
| 10 | 0.62 | 3.48 | — | | | | | Balance | |
| 11 | 0.60 | 4.99 | — | | | | | Balance | |
| 12 | 0.59 | 8.97 | — | | | | | Balance | |
| 13 | 1.01 | 2.02 | — | Zn: 7.51 | | | | Balance | |
| 14 | 1.53 | — | — | | | | | Balance | |
| 15 | 2.02 | — | — | Zr: 0.13 | | | | Balance | |
| 16 | 2.02 | 2.01 | — | | | | | Balance | |
| 17 | 1.98 | 3.47 | — | | | | | Balance | |
| 18 | 1.99 | 4.98 | — | Mn: 1.47 | Fe: 1.20 | | | Balance | |
| 19 | 2.02 | 9.03 | — | | | | | Balance | |
| 20 | 3.80 | — | — | Ti: 0.03 | B: 0.01 | | | Balance | |
| 21 | 3.81 | 2.03 | — | | | | | Balance | |
| 22 | 3.78 | 3.51 | — | | | | | Balance | |
| 23 | 3.80 | 5.01 | — | | | | | Balance | |
| 24 | 3.80 | 8.99 | — | | | | | Balance | |
| 25 | 12.01 | — | — | | | | | Balance | |
| 26 | 12.00 | 1.99 | — | | | | | Balance | |
| 27 | 11.98 | 3.47 | — | | | | | Balance | |
| 28 | 11.99 | 4.99 | — | | | | | Balance | |
| 29 | 12.03 | 9.01 | — | | | | | Balance | |
| 30 | — | — | 1.99 | | | | | Balance | Comparative |
| | | | | | | | | | example |

TABLE 3

| Alloy | Alloy component composition of insert material (unit: mass %) | | | | | | | |
|---|---|---|---|---|---|---|---|---|
| sign | Si | Cu | Mg | Others | | | Al | Note |
| 31 | — | 0.81 | 1.98 | Cr: 0.88 | Zn: 0.68 | Ni: 0.50 | Balance | Comparative |
| | | | | | | | | example |
| 32 | — | 1.22 | 1.98 | V: 090 | Zn: 0.71 | Ni: 0.49 | Balance | |
| 33 | — | 2.01 | 1.99 | | | | Balance | |
| 34 | — | 3.03 | 1.95 | | | | Balance | |
| 35 | — | 4.99 | 1.96 | | | | Balance | |
| 36 | — | 9.00 | 1.54 | | | | Balance | |
| 37 | 0.21 | — | 1.98 | Ti: 0.22 | Sn: 0.21 | Fe: 0.10 | Balance | |
| 38 | 0.20 | 1.04 | 1.99 | Zn: 0.99 | | | Balance | |
| 39 | 0.49 | 1.48 | 0.98 | Mn: 0.12 | Fe: 0.10 | | Balance | |
| 40 | 0.98 | — | 1.52 | Ti: 0.11 | Zn: 0.01 | | Balance | |
| 41 | 0.97 | 1.50 | 1.53 | Sn: 6.43 | | | Balance | |
| 42 | 1.01 | 3.02 | 0.51 | | | | Balance | |
| 43 | 2.01 | — | 1.99 | | | | Balance | |
| 44 | 1.99 | 1.54 | 0.98 | | | | Balance | |
| 45 | 1.99 | 3.01 | 0.05 | | | | Balance | |
| 46 | 2.00 | 4.99 | 0.47 | Fe: 0.15 | Ti: 0.01 | | Balance | |
| 47 | 2.02 | 8.98 | 0.52 | | | | Balance | |
| 48 | 3.81 | — | 1.53 | Fe: 0.28 | Cr: 0.03 | Ni: 0.01 | Balance | |
| 49 | 3.82 | 1.50 | 1.04 | | | | Balance | |
| 50 | 3.80 | 2.98 | 0.05 | | | | Balance | |
| 51 | 3.81 | 5.01 | 0.51 | | | | Balance | |
| 52 | 3.80 | 9.01 | 0.06 | | | | Balance | |
| 53 | 12.05 | — | 1.02 | | | | Balance | |
| 54 | 12.04 | 1.47 | 1.03 | | | | Balance | |
| 55 | 11.99 | 2.98 | 1.00 | | | | Balance | |
| 56 | 12.01 | 5.03 | 0.50 | | | | Balance | |
| 57 | 12.02 | 9.01 | 2.00 | | | | Balance | |

Next, the core material was subjected to machine cutting, the surface material was subjected to hot rolling, and the insert material was subjected to hot rolling and cold rolling such that cladding ratios, and the thickness of the insert material and the ratio of the sheet thickness of the insert material during a high-temperature heat treatment are as listed on Tables 4 to 8, and then the core material, the surface material, and the insert material were layered according to the combinations listed on Tables 4 to 8 such that the insert material was between the core material and the surface material. Among the manufacturing signs I-1 to I-104, I-107 to I-119, II-1 to H-51, III-1 to III-30, and IV-1 to IV-37 in which clad rolling was performed, for manufacturing signs I-4, I-5, I-48, I-74, I-102, and II-44 to II-51, the surface material and the insert material were layered on both sides of the core material (both sides clad), for other manufacturing signs, the surface material and the insert material were layered only on one side (one side clad). The cladding ratio and the ratio of the sheet thickness of the insert material listed on Tables 4 to 8 indicate values on one side for both of the both sides cladding material, and the one side cladding material.

TABLE 4

| | | | | | Insert material | | | | High- | | | | |
|---|---|---|---|---|---|---|---|---|---|---|---|---|---|
| | | Core | Surface | | | Thickness/ | | Solidus | temperature | 0.2% | | | |
| Manu- | | material | material | | Thick- | total sheet | | temper- | heat | proof | Elon- | | |
| facturing | | alloy | alloy | Cladding | ness | thickness | Alloy | ature | treatment | stress | gation | Roll- | |
| sign | Category | sign | sign | ratio (%) | (μm) | (%) | sign | (° C.) | (° C.) | (MPa) | (%) | ability | Note |
| I-1 | Example | H | B | 10 | 200 | 0.36 | 3 | 580 | 580 | 81 | 28 | ⊚ | |
| | of the | | | | | | | | | | | | |
| I-2 | present | H | C | 10 | 200 | 0.36 | 7 | 580 | 580 | 82 | 28 | ⊚ | |
| I-3 | disclosure | H | D | 10 | 200 | 0.36 | 9 | 580 | 580 | 82 | 29 | ⊚ | |
| I-4 | | H | D | 10 | 200 | 0.32 | 9 | 580 | 580 | 81 | 29 | ⊚ | both sides |
| | | | | | | | | | | | | | clad |
| I-5 | | H | D | 10 | 200 | 0.32 | 43 | 565 | 570 | 81 | 29 | ⊚ | both sides |
| | | | | | | | | | | | | | clad |
| I-6 | | H | D | 10 | 200 | 0.36 | 9 | 580 | 580 | 82 | 29 | ⊚ | High- |
| | | | | | | | | | | | | | temperature |
| | | | | | | | | | | | | | heating |
| | | | | | | | | | | | | | under |
| | | | | | | | | | | | | | nitrogen |
| | | | | | | | | | | | | | atmosphere, |
| | | | | | | | | | | | | | maximum |
| | | | | | | | | | | | | | rolling |
| | | | | | | | | | | | | | reduction |
| | | | | | | | | | | | | | ratio of one |
| | | | | | | | | | | | | | pass 55% |
| I-7 | | H | D | 10 | 200 | 0.36 | 9 | 580 | 580 | 82 | 29 | ⊚ | High- |
| | | | | | | | | | | | | | temperature |
| | | | | | | | | | | | | | heating |
| | | | | | | | | | | | | | under |
| | | | | | | | | | | | | | vacuum, |
| | | | | | | | | | | | | | maximum |
| | | | | | | | | | | | | | rolling |
| | | | | | | | | | | | | | reduction |
| | | | | | | | | | | | | | ratio of one |
| | | | | | | | | | | | | | pass 55% |
| I-8 | | H | D | 10 | 200 | 0.36 | 14 | 580 | 580 | 84 | 28 | ⊚ | |
| I-9 | | H | D | 10 | 200 | 0.36 | 15 | 580 | 580 | 82 | 28 | ⊚ | |
| I-10 | | H | D | 10 | 200 | 0.36 | 20 | 580 | 580 | 82 | 28 | ⊚ | |
| I-11 | | H | D | 10 | 200 | 0.36 | 25 | 580 | 580 | 86 | 29 | ⊚ | |
| I-12 | | H | D | 10 | 200 | 0.36 | 10 | 560 | 580 | 81 | 28 | ⊚ | |
| I-13 | | H | D | 10 | 200 | 0.36 | 52 | 520 | 540 | 83 | 28 | ⊚ | |
| I-14 | | H | E | 10 | 200 | 0.36 | 32 | 580 | 580 | 84 | 28 | ⊚ | |
| I-15 | | H | F-1 | 10 | 200 | 0.36 | 37 | 580 | 580 | 85 | 29 | ⊚ | |
| I-16 | | H | G | 10 | 200 | 0.36 | 38 | 580 | 580 | 82 | 28 | ⊚ | |
| I-17 | | I-1 | B | 10 | 200 | 0.36 | 8 | 575 | 575 | 100 | 31 | ⊚ | |
| I-18 | | I-1 | C | 10 | 200 | 0.36 | 13 | 570 | 575 | 97 | 31 | ⊚ | |
| I-19 | | I-1 | D | 10 | 200 | 0.36 | 33 | 570 | 570 | 99 | 30 | ⊚ | |
| I-20 | | I-1 | E | 10 | 200 | 0.36 | 39 | 570 | 570 | 103 | 30 | ⊚ | |
| I-21 | | I-1 | F-1 | 10 | 200 | 0.36 | 40 | 575 | 575 | 100 | 31 | ⊚ | |
| I-22 | | I-1 | F-1 | 10 | 200 | 0.36 | 19 | 530 | 540 | 101 | 30 | ⊚ | |
| I-23 | | I-1 | F-2 | 10 | 200 | 0.36 | 19 | 530 | 540 | 103 | 30 | ⊚ | |
| I-24 | | I-1 | F-3 | 10 | 200 | 0.36 | 19 | 530 | 540 | 102 | 30 | ⊚ | |
| I-25 | | I-1 | F-4 | 10 | 200 | 0.36 | 19 | 530 | 540 | 105 | 31 | ⊚ | |
| I-26 | | I-1 | F-5 | 10 | 200 | 0.36 | 19 | 530 | 540 | 103 | 30 | ⊚ | |
| I-27 | | I-1 | F-6 | 10 | 200 | 0.36 | 19 | 530 | 540 | 103 | 30 | ⊚ | |
| I-28 | | I-1 | F-7 | 10 | 200 | 0.36 | 19 | 530 | 540 | 103 | 31 | ⊚ | |
| I-29 | | I-1 | F-8 | 10 | 200 | 0.36 | 19 | 530 | 540 | 103 | 30 | ⊚ | |
| I-30 | | I-1 | F-9 | 10 | 200 | 0.36 | 19 | 530 | 540 | 103 | 30 | ⊚ | |
| I-31 | | I-1 | F-10 | 10 | 200 | 0.36 | 19 | 530 | 540 | 102 | 31 | ⊚ | |
| I-32 | | I-1 | G | 10 | 200 | 0.36 | 8 | 575 | 575 | 100 | 30 | ⊚ | |
| I-33 | | I-1 | H | 10 | 200 | 0.36 | 52 | 520 | 540 | 100 | 30 | ⊚ | |
| I-34 | | I-2 | H | 10 | 200 | 0.36 | 52 | 520 | 540 | 107 | 30 | ⊚ | |
| I-35 | | I-3 | H | 10 | 200 | 0.36 | 52 | 520 | 540 | 104 | 30 | ⊚ | |
| I-36 | | I-4 | H | 10 | 200 | 0.36 | 52 | 520 | 540 | 122 | 31 | ⊚ | |
| I-37 | | I-5 | H | 10 | 200 | 0.36 | 52 | 520 | 540 | 106 | 30 | ⊚ | |
| I-38 | | I-6 | H | 10 | 200 | 0.36 | 52 | 520 | 540 | 108 | 30 | ⊚ | |
| I-39 | | I-7 | H | 10 | 200 | 0.36 | 52 | 520 | 540 | 105 | 31 | ⊚ | |
| I-40 | | I-8 | H | 10 | 200 | 0.36 | 52 | 520 | 540 | 102 | 30 | ⊚ | |
| I-41 | | I-9 | H | 10 | 200 | 0.36 | 52 | 520 | 540 | 104 | 30 | ⊚ | |
| I-42 | | I-10 | H | 10 | 200 | 0.36 | 52 | 520 | 540 | 106 | 30 | ⊚ | |
| I-43 | | I-11 | H | 10 | 200 | 0.36 | 52 | 520 | 540 | 104 | 30 | ⊚ | |
| I-44 | | I-12 | H | 10 | 200 | 0.36 | 52 | 520 | 540 | 105 | 30 | ⊚ | |
| I-45 | | I-13 | H | 10 | 200 | 0.36 | 52 | 520 | 540 | 104 | 31 | ⊚ | |
| I-46 | | J | B | 10 | 200 | 0.36 | 5 | 550 | 565 | 132 | 32 | ⊚ | |
| I-47 | | J | C | 10 | 200 | 0.36 | 10 | 560 | 565 | 133 | 32 | ⊚ | |
| I-48 | | J | C | 10 | 200 | 0.32 | 10 | 560 | 565 | 132 | 32 | ⊚ | both sides |
| | | | | | | | | | | | | | clad |
| I-49 | | J | D | 10 | 200 | 0.36 | 17 | 540 | 550 | 132 | 32 | ⊚ | |
| I-50 | | J | E | 10 | 200 | 0.36 | 18 | 530 | 540 | 130 | 33 | ⊚ | |
| I-51 | | J | F-1 | 10 | 200 | 0.36 | 36 | 510 | 565 | 135 | 32 | ⊚ | |
| I-52 | | J | G | 10 | 200 | 0.36 | 10 | 560 | 565 | 135 | 32 | ⊚ | |
| I-53 | | J | H | 10 | 200 | 0.36 | 41 | 555 | 560 | 132 | 32 | ⊚ | |
| I-54 | | J | I-1 | 10 | 200 | 0.36 | 53 | 555 | 560 | 130 | 32 | ⊚ | |
| I-55 | | L | B | 10 | 200 | 0.36 | 4 | 550 | 560 | 139 | 33 | ◯ | |
| I-56 | | L | C | 10 | 200 | 0.36 | 16 | 555 | 560 | 137 | 34 | ◯ | |
| I-57 | | L | D | 10 | 200 | 0.36 | 23 | 530 | 530 | 136 | 33 | ◯ | |
| I-58 | | L | D | 10 | 200 | 0.36 | 23 | 530 | 590 | 135 | 30 | ◯ | high- |
| | | | | | | | | | | | | | temperature |
| | | | | | | | | | | | | | heating |
| | | | | | | | | | | | | | at high |
| | | | | | | | | | | | | | temperature |
| | | | | | | | | | | | | | above |
| | | | | | | | | | | | | | suitable |
| | | | | | | | | | | | | | temperature |
| | | | | | | | | | | | | | range |
| I-59 | | L | E | 10 | 200 | 0.36 | 28 | 530 | 550 | 139 | 33 | ◯ | |
| I-60 | | L | F-1 | 10 | 200 | 0.36 | 35 | 515 | 550 | 135 | 33 | ◯ | |
| I-61 | | L | G | 10 | 200 | 0.36 | 23 | 530 | 530 | 138 | 33 | ◯ | |
| I-62 | | L | H | 10 | 200 | 0.36 | 45 | 540 | 540 | 139 | 34 | ◯ | |
| I-63 | | L | I-1 | 10 | 200 | 0.36 | 50 | 540 | 560 | 135 | 33 | ◯ | |
| I-64 | | L | J | 10 | 200 | 0.36 | 55 | 525 | 530 | 136 | 33 | ◯ | |
| I-65 | | M | B | 10 | 200 | 0.36 | 19 | 530 | 550 | 143 | 34 | ◯ | |
| I-66 | | M | C | 10 | 200 | 0.36 | 21 | 555 | 555 | 142 | 34 | ◯ | |
| I-67 | | M | D | 10 | 200 | 0.36 | 22 | 540 | 555 | 141 | 34 | ◯ | |
| I-68 | | M | E | 10 | 200 | 0.36 | 26 | 555 | 555 | 141 | 35 | ◯ | |
| I-69 | | M | F-1 | 10 | 200 | 0.36 | 34 | 540 | 540 | 143 | 34 | ◯ | |
| I-70 | | M | G | 10 | 200 | 0.36 | 44 | 540 | 550 | 142 | 34 | ◯ | |

TABLE 5

| | | | | | Insert material | | | |
|---|---|---|---|---|---|---|---|---|
| | | Core | Surface | | | Thickness/ | | |
| Manu- | | material | material | Cladding | | total sheet | | Solidus |
| facturing | Cat- | alloy | alloy | ratio | Thickness | thickness | Alloy | temper-ature |
| sign | egory | sign | sign | (%) | (μm) | (%) | sign | (° C.) |
| I-71 | Ex- | M | H | 10 | 200 | 0.36 | 44 | 540 |
| I-72 | ample | M | I-1 | 10 | 200 | 0.36 | 48 | 550 |
| I-73 | of the | M | J | 10 | 200 | 0.36 | 56 | 510 |
| I-74 | present | M | J | 10 | 200 | 0.32 | 56 | 510 |
| I-75 | dis- | M | J | 10 | 200 | 0.36 | 56 | 510 |
| I-76 | closure | M | J | 10 | 200 | 0.36 | 56 | 510 |
| I-77 | | N | B | 10 | 200 | 0.36 | 11 | 540 |
| I-78 | | N | C | 10 | 200 | 0.36 | 12 | 540 |
| I-79 | | N | D | 10 | 200 | 0.36 | 24 | 530 |
| I-80 | | N | E | 10 | 200 | 0.36 | 27 | 535 |
| I-81 | | N | F-1 | 10 | 200 | 0.36 | 29 | 525 |
| I-82 | | N | F-2 | 10 | 200 | 0.36 | 29 | 525 |
| I-83 | | N | F-3 | 10 | 200 | 0.36 | 29 | 525 |
| I-84 | | N | F-4 | 10 | 200 | 0.36 | 29 | 525 |
| I-85 | | N | F-5 | 10 | 200 | 0.36 | 29 | 525 |
| I-86 | | N | F-6 | 10 | 200 | 0.36 | 29 | 525 |
| I-87 | | N | F-7 | 10 | 200 | 0.36 | 29 | 525 |
| I-88 | | N | F-8 | 10 | 200 | 0.36 | 29 | 525 |
| I-89 | | N | F-9 | 10 | 200 | 0.36 | 29 | 525 |
| I-90 | | N | F-10 | 10 | 200 | 0.36 | 29 | 525 |
| I-91 | | N | G | 10 | 200 | 0.36 | 29 | 525 |
| I-92 | | N | H | 10 | 200 | 0.36 | 42 | 530 |
| I-93 | | N | I-1 | 10 | 200 | 0.36 | 49 | 540 |
| I-94 | | N | J | 10 | 200 | 0.36 | 54 | 540 |
| I-95 | | O | B | 10 | 200 | 0.36 | 35 | 515 |
| I-96 | | O | C | 10 | 200 | 0.36 | 36 | 510 |
| I-97 | | O | D | 10 | 200 | 0.36 | 46 | 510 |
| I-98 | | O | E | 10 | 200 | 0.36 | 47 | 510 |
| I-99 | | O | F-1 | 10 | 200 | 0.36 | 51 | 510 |
| I-100 | | O | G | 10 | 200 | 0.36 | 35 | 515 |
| I-101 | | O | H | 10 | 200 | 0.36 | 52 | 520 |
| I-102 | | O | H | 10 | 200 | 0.32 | 52 | 520 |
| I-103 | | O | I-1 | 10 | 200 | 0.36 | 56 | 510 |
| I-104 | | O | J | 10 | 200 | 0.36 | 57 | 510 |
| I-105 | Comp- | G | — | — | — | — | — | — |
| I-106 | aritve | P | — | — | — | — | — | — |
| I-107 | Ex- | L | D | 10 | — | — | — | — |
| I-108 | ample | L | D | 10 | — | — | — | — |
| I-109 | | G | D | 10 | 200 | 0.36 | 42 | 530 |
| I-110 | | G | E | 10 | 200 | 0.36 | 42 | 530 |
| I-111 | | G | F-1 | 10 | 200 | 0.36 | 42 | 530 |
| I-112 | | L | D | 10 | 200 | 0.36 | 9 | 580 |
| I-113 | | L | D | 10 | 200 | 0.36 | 23 | 530 |
| I-114 | | L | D | 10 | 200 | 0.36 | 1 | >580 |
| I-115 | | L | D | 10 | 200 | 0.36 | 2 | >580 |
| I-116 | | L | D | 10 | 200 | 0.36 | 6 | >580 |
| I-117 | | L | D | 10 | 200 | 0.36 | 30 | >580 |
| I-118 | | L | D | 10 | 200 | 0.36 | 31 | >580 |
| I-119 | | Q | Q | 10 | 200 | 0.36 | 42 | 530 |

| | High- | 0.2% | | | |
|---|---|---|---|---|---|
| Manu- | temperature | proof | | | |
| facturing | heat treatment | stress | Elongation | | |
| sign | (° C.) | (MPa) | (%) | Rollability | Note |
| I-71 | 555 | 142 | 34 | ○ | |
| I-72 | 550 | 142 | 35 | ○ | |
| I-73 | 540 | 142 | 34 | ○ | |
| I-74 | 540 | 141 | 34 | ○ | Both sides clad |
| I-75 | 540 | 142 | 34 | ○ | High-temperature heating |
| | | | | | under nitrogen atmosphere, |
| | | | | | maximum rolling reduction |
| | | | | | ratio of one pass 55% |
| I-76 | 540 | 142 | 34 | ○ | High-temperature |
| | | | | | heating under vacuum, |
| | | | | | maximum rolling reduction |
| | | | | | ratio of one pass 55% |
| I-77 | 540 | 150 | 34 | ○ | |
| I-78 | 540 | 148 | 33 | ○ | |
| I-79 | 540 | 150 | 34 | ○ | |
| I-80 | 540 | 147 | 35 | ○ | |
| I-81 | 530 | 151 | 34 | ○ | |
| I-82 | 530 | 153 | 34 | ○ | |
| I-83 | 530 | 153 | 34 | ○ | |
| I-84 | 530 | 155 | 34 | ○ | |
| I-85 | 530 | 153 | 34 | ○ | |
| I-86 | 530 | 153 | 34 | ○ | |
| I-87 | 530 | 153 | 34 | ○ | |
| I-88 | 530 | 153 | 34 | ○ | |
| I-89 | 530 | 153 | 34 | ○ | |
| I-90 | 530 | 152 | 34 | ○ | |
| I-91 | 540 | 150 | 34 | ○ | |
| I-92 | 540 | 152 | 34 | ○ | |
| I-93 | 545 | 148 | 34 | ○ | |
| I-94 | 545 | 149 | 34 | ○ | |
| I-95 | 520 | 158 | 35 | Δ | |
| I-96 | 510 | 157 | 35 | Δ | |
| I-97 | 510 | 159 | 35 | Δ | |
| I-98 | 520 | 161 | 35 | Δ | |
| I-99 | 520 | 157 | 35 | Δ | |
| I-100 | 520 | 157 | 35 | Δ | |
| I-101 | 520 | 158 | 35 | Δ | |
| I-102 | 520 | 156 | 35 | Δ | Both sides clad |
| I-103 | 520 | 159 | 36 | Δ | |
| I-104 | 520 | 159 | 35 | Δ | |
| I-105 | 580 | 74 | 27 | ⊚ | Example of single alloy |
| I-106 | 460 | — | — | x | Example of single alloy, |
| | | | | | Out of range of |
| | | | | | core material |
| | | | | | composition |
| I-107 | 560 | — | — | x x | Normal hot rolled clad |
| I-108 | 520 | — | — | x x | Normal hot rolled clad |
| I-109 | 580 | 73 | 27 | ⊚ | Out of range of core |
| | | | | | material composition |
| I-110 | 580 | 71 | 26 | ⊚ | Out of range of core |
| | | | | | material composition |
| I-111 | 580 | 72 | 27 | ⊚ | Out of range of core |
| | | | | | material composition |
| I-112 | 560 | — | — | x x | High-temperature hearing |
| | | | | | below solidus temperature |
| | | | | | of insert material |
| I-113 | 520 | — | — | x x | High-temperature heating |
| | | | | | below solidus temperature |
| | | | | | of insert material |
| I-114 | 580 | — | — | x x | High-temperature heating out |
| | | | | | of range of solidus |
| | | | | | temperature of insert material |
| I-115 | 580 | — | — | x x | High-temperature heating out |
| | | | | | of range of solidus |
| | | | | | temperature of insert material |
| I-116 | 580 | — | — | x x | High-temperature heating out |
| | | | | | of range of solidus |
| | | | | | temperature of insert material |
| I-117 | 580 | — | — | x x | High-temperature heatingout |
| | | | | | of range of solidus |
| | | | | | temperature of insert material |
| I-118 | 580 | — | — | x x | High-temperature heating out |
| | | | | | of range of solidus |
| | | | | | temperature of insert material |
| I-119 | 580 | — | | ⊚ | Bonding between high-purity |
| | | | | | aluminum and insert material |

TABLE 6

| | | | | | Insert material | | | |
|---|---|---|---|---|---|---|---|---|
| | | Core | Surface | | | Thickeness | | |
| | | material | material | | | total sheet | | Solidus |
| Manufacturing | | alloy | alloy | Cladding | Thickness | thickness | Alloy | temperature |
| sign | Category | sign | sign | ratio (%) | (μm) | (%) | sign | (° C.) |
| II-1 | Example | H | D | 4 | 10 | 0.02 | 9 | 580 |
| II-2 | of the | H | D | 10 | 10 | 0.02 | 9 | 580 |
| II-3 | present | H | D | 20 | 10 | 0.02 | 9 | 580 |
| II-4 | disclosure | H | D | 25 | 10 | 0.01 | 9 | 580 |
| II-5 | | H | D | 10 | 50 | 0.09 | 9 | 580 |
| II-6 | | H | D | 10 | 100 | 0.18 | 9 | 580 |
| II-7 | | H | D | 10 | 200 | 0.36 | 9 | 580 |
| II-8 | | H | D | 10 | 300 | 0.54 | 9 | 580 |
| II-9 | | H | D | 10 | 400 | 0.72 | 9 | 580 |
| II-10 | | H | D | 10 | 500 | 0.89 | 9 | 580 |
| II-11 | | H | D | 20 | 600 | 0.95 | 9 | 580 |
| II-12 | | L | D | 10 | 10 | 0.02 | 23 | 530 |
| II-13 | | L | D | 10 | 50 | 0.09 | 23 | 530 |
| II-14 | | L | D | 10 | 100 | 0.18 | 23 | 530 |
| II-15 | | L | D | 4 | 200 | 0.38 | 23 | 530 |
| II-16 | | L | D | 10 | 200 | 0.36 | 23 | 530 |
| II-17 | | L | D | 20 | 200 | 0.32 | 23 | 530 |
| II-18 | | L | D | 25 | 200 | 0.30 | 23 | 530 |
| II-19 | | L | D | 10 | 300 | 0.54 | 23 | 530 |
| II-20 | | L | D | 10 | 400 | 0.72 | 23 | 530 |
| II-21 | | L | D | 10 | 500 | 0.89 | 23 | 530 |
| II-22 | | L | D | 10 | 600 | 1.07 | 23 | 530 |
| II-23 | | L | F-1 | 10 | 10 | 0.02 | 35 | 515 |
| II-24 | | L | F-1 | 10 | 50 | 0.09 | 35 | 515 |
| II-25 | | L | F-1 | 10 | 100 | 0.18 | 35 | 515 |
| II-26 | | L | F-1 | 4 | 200 | 0.38 | 35 | 515 |
| II-27 | | L | F-1 | 10 | 200 | 0.36 | 35 | 515 |
| II-28 | | L | F-1 | 20 | 200 | 0.32 | 35 | 515 |
| II-29 | | L | F-1 | 25 | 200 | 0.30 | 35 | 515 |
| II-30 | | L | F-1 | 10 | 300 | 0.54 | 35 | 515 |
| II-31 | | L | F-1 | 10 | 400 | 0.72 | 35 | 515 |
| II-32 | | L | F-1 | 10 | 500 | 0.89 | 35 | 515 |
| II-33 | | N | D | 10 | 10 | 0.02 | 24 | 530 |
| II-34 | | N | D | 10 | 50 | 0.09 | 24 | 530 |
| II-35 | | N | D | 10 | 100 | 0.18 | 24 | 530 |
| II-36 | | N | D | 10 | 200 | 0.36 | 24 | 530 |
| II-37 | | N | D | 10 | 300 | 0.54 | 24 | 530 |
| II-38 | | N | D | 4 | 400 | 0.76 | 24 | 530 |
| II-39 | | N | D | 10 | 400 | 0.72 | 24 | 530 |
| II-40 | | N | D | 20 | 400 | 0.64 | 24 | 530 |
| II-41 | | N | D | 25 | 400 | 0.59 | 24 | 530 |
| II-42 | | N | D | 10 | 500 | 0.89 | 24 | 530 |
| II-43 | | N | D | 4 | 600 | 1.14 | 24 | 530 |
| II-44 | | N | D | 4 | 10 | 0.02 | 24 | 530 |
| II-45 | | N | D | 4 | 100 | 0.18 | 24 | 530 |
| II-46 | | N | D | 4 | 200 | 0.36 | 24 | 530 |
| II-47 | | N | D | 4 | 400 | 0.72 | 24 | 530 |
| II-48 | | N | D | 10 | 400 | 0.63 | 24 | 530 |
| II-49 | | N | D | 20 | 400 | 0.47 | 24 | 530 |
| II-50 | | N | D | 25 | 400 | 0.40 | 24 | 530 |
| II-51 | Comparative | N | D | 35 | 400 | 0.23 | 24 | 530 |
| | Example | | | | | | | |

| | High- | 0.2% | | | |
|---|---|---|---|---|---|
| | temperature | proof | | | |
| Manufacturing | heat treatment | stress | Elongation | | |
| sign | (° C.) | MPa | (%) | Rollability | Note |
| II-1 | 580 | 82 | 28 | ⊚ | |
| II-2 | 580 | 83 | 28 | ⊚ | |
| II-3 | 580 | 82 | 29 | ⊚ | |
| II-4 | 580 | 80 | 28 | ⊚ | |
| II-5 | 580 | 83 | 28 | ⊚ | |
| II-6 | 580 | 84 | 28 | ⊚ | |
| II-7 | 580 | 82 | 29 | ⊚ | |
| II-8 | 580 | 82 | 28 | ⊚ | |
| II-9 | 580 | 85 | 29 | ⊚ | |
| II-10 | 580 | 83 | 28 | ⊚ | |
| II-11 | 580 | 82 | 29 | ⊚ | |
| II-12 | 530 | 138 | 33 | ○ | |
| II-13 | 530 | 138 | 34 | ○ | |
| II-14 | 530 | 135 | 33 | ○ | |
| II-15 | 530 | 136 | 33 | ○ | |
| II-16 | 530 | 136 | 33 | ○ | |
| II-17 | 530 | 137 | 34 | ○ | |
| II-18 | 530 | 134 | 33 | ○ | |
| II-19 | 530 | 136 | 34 | ○ | |
| II-20 | 530 | 136 | 33 | ○ | |
| II-21 | 530 | 139 | 33 | ○ | |
| II-22 | 530 | 138 | 32 | ○ | Thickness of insert material/ |
| | | | | | total sheet thickness is 1% |
| | | | | | or larger |
| II-23 | 550 | 137 | 33 | ○ | |
| II-24 | 550 | 136 | 34 | ○ | |
| II-25 | 550 | 136 | 33 | ○ | |
| II-26 | 550 | 136 | 33 | ○ | |
| II-27 | 550 | 135 | 33 | ○ | |
| II-28 | 550 | 138 | 34 | ○ | |
| II-29 | 550 | 133 | 33 | ○ | |
| II-30 | 550 | 136 | 34 | ○ | |
| II-31 | 550 | 135 | 34 | ○ | |
| II-32 | 550 | 136 | 33 | ○ | |
| II-33 | 540 | 149 | 34 | ○ | |
| II-34 | 540 | 150 | 34 | ○ | |
| II-35 | 540 | 149 | 34 | ○ | |
| II-36 | 540 | 150 | 34 | ○ | |
| II-37 | 540 | 147 | 35 | ○ | |
| II-38 | 540 | 148 | 34 | ○ | |
| II-39 | 540 | 149 | 34 | ○ | |
| II-40 | 540 | 149 | 34 | ○ | |
| II-41 | 540 | 146 | 33 | ○ | |
| II-42 | 540 | 148 | 34 | ○ | |
| II-43 | 540 | 148 | 32 | ○ | Thickness of insert material/ |
| | | | | | total sheet thickness |
| | | | | | is 1% or larger |
| II-44 | 540 | 148 | 34 | ○ | Both sides clad |
| II-45 | 540 | 147 | 34 | ○ | Both sides clad |
| II-46 | 540 | 148 | 34 | ○ | Both sides clad |
| II-47 | 540 | 148 | 34 | ○ | Both sides clad |
| II-48 | 540 | 148 | 34 | ○ | Both sides clad |
| II-49 | 540 | 146 | 33 | ○ | Both sides clad |
| II-50 | 540 | 140 | 32 | ○ | Both sides clad |
| II-51 | 540 | 127 | 29 | ○ | Both sides clad, |
| | | | | | above upper limit of |
| | | | | | cladding ratio |

TABLE 7

| | | | | | Insert material | |
|---|---|---|---|---|---|---|
| | | Core | Surface | | | Thickness/total |
| Manufacturing | | material | material | Cladding | Thickeness | sheet thickness |
| sign | Category | alloy sign | alloy sign | ratio (%) | (μm) | (%) |
| III-1 | Example | H | B | 4 | 200 | 0.38 |
| III-2 | of the | H | B | 10 | 200 | 0.36 |
| III-3 | present | H | B | 20 | 200 | 0.32 |
| III-4 | disclosure | H | B | 25 | 200 | 0.30 |
| III-5 | | H | C | 10 | 200 | 0.36 |
| III-6 | | H | F-1 | 10 | 200 | 0.36 |
| III-7 | | L | B | 10 | 200 | 0.36 |
| III-8 | | L | C | 4 | 200 | 0.38 |
| III-9 | | L | C | 10 | 200 | 0.36 |
| III-10 | | L | C | 20 | 200 | 0.32 |
| III-11 | | L | C | 25 | 200 | 0.30 |
| III-12 | | L | F-1 | 10 | 200 | 0.36 |
| III-13 | | N | B | 10 | 200 | 0.36 |
| III-14 | | N | C | 10 | 200 | 0.36 |
| III-15 | | N | F-1 | 10 | 10 | 0.02 |
| III-16 | | N | F-1 | 10 | 50 | 0.09 |
| III-17 | | N | F-1 | 10 | 200 | 0.36 |
| III-18 | | N | F-1 | 10 | 500 | 0.89 |
| III-19 | | N | F-2 | 10 | 500 | 0.89 |
| III-20 | | N | F-3 | 10 | 500 | 0.89 |
| III-21 | | N | F-4 | 10 | 500 | 0.89 |
| III-22 | | N | F-5 | 10 | 500 | 0.89 |
| III-23 | | N | F-6 | 10 | 500 | 0.89 |
| III-24 | | N | F-7 | 10 | 500 | 0.89 |
| III-25 | | N | F-8 | 10 | 500 | 0.89 |
| III-26 | | N | F-9 | 10 | 500 | 0.89 |
| III-27 | | N | F-10 | 10 | 500 | 0.89 |
| III-28 | Comparative | H | A | 10 | 200 | 0.36 |
| | Example | | | | | |
| III-29 | | L | A | 10 | 200 | 0.36 |
| III-30 | | N | A | 10 | 200 | 0.36 |

| | Insert Material | | | | |
|---|---|---|---|---|---|
| | | Solidus | High-temperature | Surface | |
| Manufacturing | | temperature | heat treatment | hardness | |
| sign | Alloy sign | (° C.) | (° C.) | HV | Note |
| III-1 | 3 | 580 | 580 | 30 | |
| III-2 | 3 | 580 | 580 | 31 | |
| III-3 | 3 | 580 | 580 | 31 | |
| III-4 | 3 | 580 | 580 | 31 | |
| III-5 | 7 | 580 | 580 | 36 | |
| III-6 | 37 | 580 | 580 | 44 | |
| III-7 | 4 | 550 | 560 | 31 | |
| III-8 | 16 | 555 | 560 | 35 | |
| III-9 | 16 | 555 | 560 | 36 | |
| III-10 | 16 | 555 | 560 | 35 | |
| III-11 | 16 | 555 | 560 | 35 | |
| III-12 | 35 | 515 | 550 | 44 | |
| III-13 | 11 | 540 | 540 | 31 | |
| III-14 | 12 | 540 | 540 | 35 | |
| III-15 | 29 | 525 | 530 | 44 | |
| III-16 | 29 | 525 | 530 | 43 | |
| III-17 | 29 | 525 | 530 | 42 | |
| III-18 | 29 | 525 | 530 | 44 | |
| III-19 | 29 | 525 | 530 | 47 | |
| III-20 | 29 | 525 | 530 | 46 | |
| III-21 | 29 | 525 | 530 | 53 | |
| III-22 | 29 | 525 | 530 | 48 | |
| III-23 | 29 | 525 | 530 | 47 | |
| III-24 | 29 | 525 | 530 | 48 | |
| III-25 | 29 | 525 | 530 | 47 | |
| III-26 | 29 | 525 | 530 | 47 | |
| III-27 | 29 | 525 | 530 | 46 | |
| III-28 | 3 | 580 | 580 | 21 | Out of range of |
| | | | | | surface material |
| | | | | | composition |
| III-29 | 4 | 550 | 560 | 22 | Out of range of |
| | | | | | surface material |
| | | | | | composition |
| III-30 | 11 | 540 | 540 | 21 | Out of range of |
| | | | | | surface material |
| | | | | | composition |

TABLE 8

| | | | | | Insert matetial | | |
|---|---|---|---|---|---|---|---|
| | | | | | | Thickness/ | |
| | | Core | Surface | | | total sheet | |
| Manufacturing | | material | material | Cladding | Thickness | temperature | Alloy |
| sign | Category | alloy sign | alloy sign | ration (%) | (μm) | (%) | sign |
| IV-1 | Example of | H | C | 4 | 200 | 0.38 | 7 |
| IV-2 | the present | H | C | 10 | 200 | 0.36 | 7 |
| IV-3 | disclosure | H | C | 20 | 200 | 0.32 | 7 |
| IV-4 | | H | C | 25 | 200 | 0.30 | 7 |
| IV-5 | | H | D | 10 | 200 | 0.36 | 9 |
| IV-6 | | H | E | 10 | 200 | 0.36 | 32 |
| IV-7 | | H | G | 10 | 200 | 0.36 | 38 |
| IV-8 | | L | C | 10 | 200 | 0.36 | 16 |
| IV-9 | | L | D | 10 | 200 | 0.36 | 23 |
| IV-10 | | L | F-1 | 4 | 200 | 0.38 | 35 |
| IV-11 | | L | F-1 | 10 | 200 | 0.36 | 35 |
| IV-12 | | L | F-1 | 20 | 200 | 0.32 | 35 |
| IV-13 | | L | F-1 | 25 | 200 | 0.30 | 35 |
| IV-14 | | L | H | 10 | 200 | 0.36 | 45 |
| IV-15 | | L | I-1 | 10 | 200 | 0.36 | 50 |
| IV-16 | | L | J | 10 | 200 | 0.36 | 55 |
| IV-17 | | N | C | 10 | 200 | 0.36 | 12 |
| IV-18 | | N | D | 10 | 200 | 0.36 | 24 |
| IV-19 | | N | F-1 | 10 | 200 | 0.36 | 29 |
| IV-20 | | N | F-2 | 10 | 200 | 0.36 | 29 |
| IV-21 | | N | F-3 | 10 | 200 | 0.36 | 29 |
| IV-22 | | N | F-4 | 10 | 200 | 0.36 | 29 |
| IV-23 | | N | F-5 | 10 | 200 | 0.36 | 29 |
| IV-24 | | N | F-6 | 10 | 200 | 0.36 | 29 |
| IV-25 | | N | F-7 | 10 | 200 | 0.36 | 29 |
| IV-26 | | N | F-8 | 10 | 200 | 0.36 | 29 |
| IV-27 | | N | F-9 | 10 | 200 | 0.36 | 29 |
| IV-28 | | N | F-10 | 10 | 200 | 0.36 | 29 |
| IV-29 | | N | H | 10 | 200 | 0.36 | 42 |
| IV-30 | | N | I-1 | 10 | 200 | 0.36 | 49 |
| IV-31 | | N | J | 10 | 10 | 0.02 | 54 |
| IV-32 | | N | J | 10 | 50 | 0.09 | 54 |
| IV-33 | | N | J | 10 | 200 | 0.36 | 54 |
| IV-34 | | N | J | 10 | 500 | 0.89 | 54 |
| IV-35 | Comparative | L | K | 10 | 200 | 0.36 | 29 |
| | Example | | | | | | |
| IV-36 | | N | K | 10 | 200 | 0.36 | 29 |
| IV-37 | | L | F-1 | 1 | 200 | 0.39 | 35 |

| | Insert material | | | | | |
|---|---|---|---|---|---|---|
| | Solidus | High-temperature | SCC | SS mark | | |
| Manufacturing | temperature | heat treatment | resistance | resistance | | |
| sign | (° C.) | (° C.) | (to J) | (to J) | (to G) | Note |
| IV-1 | 580 | 580 | ⊚ | ⊚ | ○ | |
| IV-2 | 580 | 580 | ⊚ | ⊚ | ⊚ | |
| IV-3 | 580 | 580 | ⊚ | ⊚ | ⊚ | |
| IV-4 | 580 | 580 | ⊚ | ⊚ | ⊚ | |
| IV-5 | 580 | 580 | ⊚ | ⊚ | ⊚ | |
| IV-6 | 580 | 580 | ⊚ | ⊚ | ⊚ | |
| IV-7 | 580 | 580 | ⊚ | ⊚ | ○ | |
| IV-8 | 555 | 560 | ⊚ | ⊚ | ⊚ | |
| IV-9 | 530 | 530 | ⊚ | ⊚ | ⊚ | |
| IV-10 | 515 | 550 | ⊚ | ⊚ | ○ | |
| IV-11 | 515 | 550 | ⊚ | ⊚ | ⊚ | |
| IV-12 | 515 | 550 | ⊚ | ⊚ | ⊚ | |
| IV-13 | 515 | 550 | ⊚ | ⊚ | ⊚ | |
| IV-14 | 540 | 540 | ⊚ | ⊚ | Δ | |
| IV-15 | 540 | 560 | ○ | ○ | x | |
| IV-16 | 525 | 530 | ○ | ○ | x | |
| IV-17 | 540 | 540 | ⊚ | ⊚ | ⊚ | |
| IV-18 | 530 | 540 | ⊚ | ⊚ | ⊚ | |
| IV-19 | 525 | 530 | ⊚ | ⊚ | ⊚ | |
| IV-20 | 525 | 530 | ⊚ | ⊚ | ⊚ | |
| IV-21 | 525 | 530 | ⊚ | ⊚ | ⊚ | |
| IV-22 | 525 | 530 | ⊚ | ⊚ | ⊚ | |
| IV-23 | 525 | 530 | ⊚ | ⊚ | ⊚ | |
| IV-24 | 525 | 530 | ⊚ | ⊚ | ⊚ | |
| IV-25 | 525 | 530 | ⊚ | ⊚ | ⊚ | |
| IV-26 | 525 | 530 | ⊚ | ⊚ | ⊚ | |
| IV-27 | 525 | 530 | ⊚ | ⊚ | ⊚ | |
| IV-28 | 525 | 530 | ⊚ | ⊚ | ⊚ | |
| IV-29 | 530 | 540 | ⊚ | ⊚ | Δ | |
| IV-30 | 540 | 545 | ○ | ○ | x | |
| IV-31 | 540 | 545 | ○ | ○ | x | IV-31 |
| IV-32 | 540 | 545 | ○ | ○ | x | |
| IV-33 | 540 | 545 | ○ | ○ | x | |
| IV-34 | 540 | 545 | ○ | ○ | x | |
| IV-35 | 525 | 530 | x | x | x | Out of range of surface |
| | | | | | | material composition |
| IV-36 | 525 | 530 | x | x | x | Out of range of surface |
| | | | | | | material composition |
| IV-37 | 515 | 550 | x | x | x | Below lower limit of |
| | | | | | | cladding ratio |

Subsequently, in order to perform bonding utilizing a liquid phase of the insert material, a high-temperature heat treatment was performed at the temperatures on Tables 4 to 8 for two hours. A high-temperature heat treatment was performed, for the manufacturing signs I-6 and I-75, under a nitrogen atmosphere which is a non-oxidizing atmosphere, for the manufacturing signs I-7 and I-76, under vacuum which is a non-oxidizing atmosphere, and for other manufacturing signs, in the atmosphere which is an oxidizing atmosphere. After a high-temperature heat treatment, hot rolling was performed to obtain a sheet having a thickness 3.0 mm. For the manufacturing signs I-6, I-7, I-75, and I-76 on which a high-temperature heat treatment was performed under a non-oxidizing atmosphere, the maximum rolling reduction ratio of one pass was 55%; for other manufacturing signs, the maximum rolling reduction ratio of one pass was 40%. A hot rolled sheet was subjected to process annealing under conditions of 370° C. for two hours by using an air furnace, and then to cold rolling until a thickness of 1.0 mm was attained.

The obtained cold rolled sheet was subjected to a recrystallization heat treatment at 520° C. for 20 seconds in a niter furnace, then to forced-air cooling by a fan to room temperature to manufacture an aluminum alloy clad material. In Table 5, manufacturing signs I-105 and I-106 are test materials of single alloy, and the manufacturing signs I-105 to I-108 did not use an insert material.

For each of the thus obtained sheet materials, a JIS 5 test piece was cut out in a direction parallel to the rolling direction, and the 0.2% proof stress and elongation which is one of indices of formability were evaluated by tensile test. The results thereof are listed on Tables 4 to 6. In Table 5, materials which were not used and items which were not evaluated are represented by “−” in the Table. For manufacturing signs I-106 to I-108 and I-112 to I-118 for which values are not described in the 0.2% proof stress and elongation sections, a large amount of cracks or joining interface peeling occurred during rolling, or a large amount of material surface local swelling occurred after process annealing, thereby failing to evaluate the material. The manufacturing sign I-119 will be described below as a reference Example.

For the sheet material which was obtained in the manner as above, a Vickers hardness test was performed. The Vickers hardness test was performed in accordance with JIS Z2244. The test force was 0.01 Kgf and the position of the hardness measurement was on the rolling surface which is the surface on the side of the surface material. The result thereof is listed on Table 7.

Further, an SCC test was performed in the following procedure. Before the SCC test, a 30% cold working and then a 120° C.×1 week annealing were performed in advance as a sensitizing processing. After the sensitizing processing, a 2 A test piece (length: 100 mm, width: 20 mm, thickness: 1 mm, taken out from the direction at an angle of 90° with respect to the rolling direction) was taken out in accordance with JIS H8711, a load stress was applied to one surface of each test piece by three-point bending, and the test piece was placed in a salt spray bath as it was to be subjected to an SCC test. The load stress was set to 25 kgf/mm², and for one side cladding material, a test was performed such that the surface on the side of the surface material was the outside of the bending. The result is listed on Table 8. The SCC resistance was evaluated by comparing with the alloy sign J equivalent to AA5182 alloy which is widely used as an automotive body sheet material (indicated as (to J) in Table 8). The sign “x” was assigned when a crack occurred in a time shorter than that of a comparative material; the sign “∘” was assigned when a crack did not occur in the same time as or in a time longer than that of the comparative material; and the sign “⊚” was assigned when a crack did not occur in a particularly long time or a crack did not occur.

In addition, an evaluation of the SS mark resistance was also performed according to the following procedure. From each sheet material obtained as mentioned above, a JIS 5 test piece was cut out in a direction parallel to the rolling direction, and 20% tensile deformation (stretch) was applied thereto at room temperature. Thereafter, observation was performed by visual inspection after lightly polishing the surface thereof on the surface material side with an emery paper (#1000) in order to easily visually recognize an SS mark. The SS mark resistance was evaluated by comparing with an alloy sign J equivalent to AA5182 alloy which is widely used as an automotive body sheet material or an alloy sign G equivalent to AA5052 alloy which is also widely used as an automotive body sheet material (indicated as (to J) and (to G), respectively in Table 8). As mentioned above, since Mg is a component which adversely affects the SCC resistance and SS mark resistance, the comparison with G alloy whose content of Mg is smaller than that of J alloy is an evaluation in a more strict condition. The “x” sign was assigned when the number of SS marks was particularly larger than that of a comparative material; the “Δ” sign was assigned when the number of SS marks was slightly larger than that of a comparative material; the “o” sign was assigned when the number of SS marks was the same as or slightly smaller than that of a comparative material; and the “⊚” sign was assigned when the number of SS marks was particularly small or an SS mark was not visually recognized.

Still further, the rollability was also listed on Tables 4 to 6. The meaning of each sign is as follows. ⊚: favorable rollability, ∘: almost favorable rollability, ΔA: some edge crack, x: crocodile crack, xx: joining interface peeling during rolling, or a large amount of material surface local swelling occurred after process annealing.

Tables 4 to 8 describes a solidus temperature of the insert material, which was determined by the differential thermal analysis (DTA).

The starting point of a large endothermic peak whose peak height was 5 μV (the electromotive force of a thermocouple indicating the difference with the reference substance: μV) or higher, the endothermic peak being generated when the temperature of the test piece cut out from each of the above-mentioned sheet materials was elevated from 450° C. to 700° C. at 5° C./min was set to the solidus temperature. In cases in which a plurality of subject endothermic peaks exist, the starting point of the endothermic peak on the lowest temperature may be set to the solidus temperature. The starting point was defined by a point where, when a line on the lower temperature side of the subject endothermic peak is extended to the higher temperature side, the line begins to change into a curve due to the endothermic peak and the extended line begins to departs from the line.

Here, Tables 4 to 5 show results obtained by mainly studying an effect of “the alloy composition and high-temperature heat treatment conditions of the core material surface material, and insert material” on “the strength, elongation, adhesive properties of the joining interface, and rollability”; Table 6 is a result obtained by mainly studying an effect of “the sheet thickness (or the ratio thereof) of the core material, surface material and insert material” on “the strength, elongation, adhesive properties of the joining interface and rollability”. In a similar manner, Table 7 is a result obtained by mainly studying an effect of “the alloy composition of the surface material the sheet thickness of the core material, surface material, and insert material (or the ratio thereof)” on “the surface hardness”; Table 8 is a result obtained by mainly studying an effect of “the alloy composition of the surface material, the sheet thickness of the core material, surface material, and insert material (or the ratio thereof)” on “the SCC resistance and SS mark resistance”.

As obvious from the results in Tables 4 to 8, for materials of the present disclosure (manufacturing signs I-1 to I-104, II-1 to II-50, II-1 to III-27, and IV-1 to IV-34), excellent performances were exhibited, and the strength, the elongation which is index of the formability, surface hardness, SCC resistance and SS mark resistance were excellent compared with a clad sheet material of Comparative Example or a sheet material comprising a single alloy.

On the other hand, for a clad sheet material of the manufacturing signs I-109 to I-111 or a single alloy sheet material of the manufacturing sign I-105 in which the composition of the core material was out of the lower limit defined in the present disclosure, it was found that the strength and elongation were deteriorated compared with an example of the present disclosure. For the manufacturing sign I-106 in which the content of Mg of the core material is out of the upper limit defined in the present disclosure, rolling could not be completed due to a crack generated during rolling.

Further, for the manufacturing signs I-107 and I-108 in which only a core material and a surface material were layered in accordance with an ordinary method and was subjected to hot rolled cladding, the manufacturing signs I-112 and I-113 in which a high-temperature heating was performed at a temperature lower than the solidus temperature of an insert material, and manufacturing signs I-114 to I-118 in which the solidus temperature of an insert material was out of the scope of the present disclosure, an adhesion failure occurred.

Still further, for the manufacturing sign H-51 in which the ratio of the surface material with respect to the total sheet thickness was above the defined range, the strength and elongation were deteriorated compared with a material of the present disclosure material (for example, II-50) comprising the same combination of the core material and surface material. On the other hand, for the manufacturing sign IV-37 in which the ratio of surface material with respect to the total sheet thickness was below the defined range, the SCC resistance and the SS mark resistance were considerably decreased compared with a material of the present disclosure material (for example, the manufacturing sign IV-10) comprising the same combination of the core material and surface material.

Further, for the manufacturing signs IV-35 and IV-36 in which the composition of the surface material was out of the upper limit defined in the present disclosure, deterioration of the SCC resistance and SS mark resistance was more observed compared with a material of the present disclosure (for example, manufacturing signs IV-16 and IV-33).

Still further, for the manufacturing signs III-28 to 30 in which the composition of the surface material was out of the lower limit defined in the present disclosure, decrease in the surface hardness was more observed compared with a material of the present disclosure.

The manufacturing signs I-6, I-7, I-75, and I-76 of the materials of the present disclosure are those to verify the effect of the high-temperature heat treatment in a non-oxidizing atmosphere, and the rolling reduction ratio of one pass thereof can be made larger compared with materials of the present disclosure of other manufacturing signs in which a high-temperature heat treatment was performed in an oxidizing atmosphere (in the air).

For the manufacturing sign I-119, a pure aluminum having a high melting point which was much higher than that of the insert material was combined and a high-temperature heat treatment was performed in order to verify the technique used in the present disclosure for bonding the insert material and core material, or the insert material and surface material by utilizing a liquid phase of the insert material. A favorable bonding was confirmed after high-temperature heating in a similar manner to the material of the present disclosure. For the manufacturing sign I-119, evaluation was not performed except for the rollability.

### CROSS-REFERENCE TO RELATED APPLICATION

The present application is based on Japanese Patent Application No. 2011-241445 filed on Nov. 2, 2011. The description, Claims, and Drawings thereof are incorporated herein by reference.

1. An aluminum alloy clad material for forming comprising:
an aluminum alloy core material containing Mg: 3.0 to 10% (mass %, the same hereinafter), and the remainder being Al and inevitable impurities;
an aluminum alloy surface material that is cladded on one side or both sides of the core material the thickness of the clad for one side being 3 to 30% of the total sheet thickness, and that has a composition including Mg: 0.4 to 5.0%, and the remainder being Al and inevitable impurities; and
an aluminum alloy insert material that is interposed between the core material and the surface material and has a solidus temperature of 580° C. or lower.

2. The aluminum alloy clad material for forming according to claim 1, wherein
the core material and the surface material, or either thereof contains one or more of Zn: 0.01 to 2.0%, Cu: 0.03 to 2.0%, Mn: 0.03 to 1.0%, Cr: 0.01 to 0.40%, Zr: 0.01 to 0.40%, V: 0.01 to 0.40%, Fe: 0.03 to 0.5%, Si: 0.03 to 0.5%, and Ti: 0.005 to 0.30%.

3. The aluminum alloy clad material for forming according to claim 1, wherein
setting the amount of Si (mass %, the same hereinafter) contained in the insert material to x and the amount of Cu (mass %, the same hereinafter) contained in the insert material to y, the following expressions (1) to (3) are satisfied at the same time:
x≧0 (1)
y≧0 (2)
y≧−11.7x+2.8 (3).

4. The aluminum alloy clad material for forming according to claim 2, wherein
setting the amount of Si (mass %, the same hereinafter) contained in the insert material to x and the amount of Cu (mass %, the same hereinafter) contained in the insert material to y, the following expressions (1) to (3) are satisfied at the same time:
x≧0 (1)
y≧0 (2)
y≧−11.7x+2.8 (3).

5. The aluminum alloy clad material for forming according to claim 1, wherein
the amount of Mg contained in the insert material is 0.05 to 2.0 mass %, and
setting the amount of Si (mass %, the same hereinafter) contained in the insert material to x, and
the amount of Cu (mass %, the same hereinafter) contained in the insert material to y, the following expressions (4) to (6) are satisfied at the same time:
x≧0 (4)
y≧0 (5)
y≧−10.0x+1.0 (6).

6. The aluminum alloy clad material for forming according to claim 2, wherein
the amount of Mg contained in the insert material is 0.05 to 2.0 mass %, and
setting the amount of Si (mass %, the same hereinafter) contained in the insert material to x, and
the amount of Cu (mass %, the same hereinafter) contained in the insert material to y, the following expressions (4) to (6) are satisfied at the same time:
x≧0 (4)
y≧0 (5)
y≧−10.0x+1.0 (6).

7. The aluminum alloy clad material for forming according to claim 1, wherein
the solidus temperature of the insert material is lower than the solidus temperature of the core material and the solidus temperature of the surface material.

8. The aluminum alloy clad material for forming according to claim 2, wherein
the solidus temperature of the insert material is lower than the solidus temperature of the core material and the solidus temperature of the surface material.

9. The aluminum alloy clad material for forming according to claim 3, wherein
the solidus temperature of the insert material is lower than the solidus temperature of the core material and the solidus temperature of the surface material.

10. The aluminum alloy clad material for forming according to claim 4, wherein
the solidus temperature of the insert material is lower than the solidus temperature of the core material and the solidus temperature of the surface material.

11. The aluminum alloy clad material for forming according to claim 5, wherein
the solidus temperature of the insert material is lower than the solidus temperature of the core material and the solidus temperature of the surface material.

12. The aluminum alloy clad material for forming according to claim 6, wherein
the solidus temperature of the insert material is lower than the solidus temperature of the core material and the solidus temperature of the surface material.

13. The aluminum alloy clad material for forming according to claim 1, wherein
the thickness of the insert material when the core material, the insert material and the surface material are bonded in a high-temperature heat treatment is 10 μm or larger.

14. The aluminum alloy clad material for forming according to claim 2, wherein
the thickness of the insert material when the core material, the insert material and the surface material are bonded in a high-temperature heat treatment is 10 μm or larger.

15. The aluminum alloy clad material for forming according to claim 3, wherein
the thickness of the insert material when the core material, the insert material and the surface material are bonded in a high-temperature heat treatment is 10 μm or larger.

16. The aluminum alloy clad material for forming according to claim 4, wherein
the thickness of the insert material when the core material, the insert material and the surface material are bonded in a high-temperature heat treatment is 10 μm or larger.

17. The aluminum alloy clad material for forming according to claim 5, wherein
the thickness of the insert material when the core material, the insert material and the surface material are bonded in a high-temperature heat treatment is 10 μm or larger.

18. The aluminum alloy clad material for forming according to claim 6, wherein
the thickness of the insert material when the core material, the insert material and the surface material are bonded in a high-temperature heat treatment is 10 μm or larger.

19. The aluminum alloy clad material for forming according to claim 7, wherein
the thickness of the insert material when the core material, the insert material and the surface material are bonded in a high-temperature heat treatment is 10 μm or larger.

20. The aluminum alloy clad material for forming according to claim 8, wherein
the thickness of the insert material when the core material, the insert material and the surface material are bonded in a high-temperature heat treatment is 10 μm or larger.
